(19) United States
(12) Patent Application Publication
(10) Pub. No.: US 2002/0077860 A1
(43) Pub. Date: Jun. 20, 2002

(54) Method and system for assisting in determining when to order supplemental medical information about a patient

(76) Inventors: Jocelyn Branham Earnest, Lynchburg, VA (US); Timothy Adam Hilton, Lynchburg, VA (US)

Correspondence Address: Hunton & Williams, 1900 K Street, N.W., Washington, DC, 20006-1109, US

(21) Appl. No.: 09/739,594

(22) Filed: Dec. 18, 2000

(51) Int. Cl. G06F 17/60

(52) U.S. Cl. 705/3; 705/4

(57) ABSTRACT

A method and system for assisting in determining when to order supplemental medical information about a patient. A system implementing the method receives patient information from a user and returns a determination whether to order supplemental medical information about the patient. Alternatively, the system provides the user with information to assist the user in determining whether to order supplemental medical information. The system can be updated to reflect the latest procedures and guidelines for determining when to order supplemental medical information. The system can include a tutorial system, which educates users on how to use the system, and periodic refresher tests, which ensure that the users are skilled enough to continue to use the system. The system can also incorporate the use of checksheets for inserting into patient files and auditing business operations.

### BACKGROUND OF THE INVENTION

The present invention relates generally to on-line systems for providing content to users. More particularly, the present invention relates to a method and system for determining when to order supplemental medical information about a patient. This information is typically sought when an insurance provider or an adjuster, or an agent of an insurance provider or adjuster (all of which are referred to as the “insurer” herein) is examining a patient who is seeking insurance coverage or whose insurance rate is being adjusted.

Insurance companies strive to provide insurance coverage at the lowest possible cost to the consumer. Part of the overall cost of coverage is the administrative cost associated with determining whether a potentially insured patient or a currently insured patient (both are referred to as the “patient” herein) will be extended insurance coverage, and if so, at what insurance rate. Another part of the overall cost of insurance coverage is the business cost associated with undercharging an insured person whose medical condition calls for a higher insurance rate. An insurance company (or an insurer) must balance the administrative cost of determining whether a patient has medical conditions that would increase the insurance rate against the business cost of undercharging the patient. To reduce the overall cost, the insurer must gather accurate medical information about the patient at the lowest possible cost, and not gather additional information if it would be unnecessary to determine the proper insurance rate. Therefore, the information-gathering process must be as fast, inexpensive, and accurate as possible.

The current method for gathering medical information begins with obtaining a completed insurance form (or “application”) containing basic medical information from the patient. The insurance form is reviewed by an insurance underwriter who decides whether to order more information about the patient from the patient's doctor. The additional information (“supplemental medical information”) solicited from the patient's doctor is typically known as an Attending Physician Statement (“APS”). The underwriter makes his decision whether to order supplemental medical information by comparing the medical information disclosed in the patient's application to a set of supplemental medical information ordering guidelines (“guidelines”) promulgated by the insurer. A methodology that the insurance underwriter employs in making his decision is governed by supplemental medical information ordering procedures (“procedures”), sometimes known as Attending Physician Statement Procedures (“APSPs”), that are typically promulgated by an insurer. The guidelines that the insurance underwriters use may have many names, depending on the promulgating party, but they are sometimes known as Attending Physician Statement Guidelines (“APSGs”). The guidelines are essentially a listing of medical conditions that indicate whether supplemental medical information is required for each condition. The guidelines generally cannot be properly followed without understanding or using the procedures.

A failure of this system can raise the overall cost of coverage in at least two ways. On one hand, if the patient has medical conditions that call for a higher insurance rate, but supplemental medical information is not ordered, then the overall cost of coverage increases because the patient will be undercharged for insurance coverage. On the other hand, if a patient's application does not warrant ordering supplemental medical information, but supplemental medical information is ordered anyway, then the overall cost of insurance coverage rises because ordering the supplemental medical information constitutes an unnecessary administrative expense.

The current system suffers from various problems. The system is expensive because the person who determines whether to order supplemental medical information is typically an insurance underwriter. Insurance underwriters are relatively senior staff members who cost more to employ than many other employees, such as case managers, who could perform this task with the proper knowledge and training. Furthermore, there are relatively few insurance underwriters compared to the number of applications, which causes a backlog of insurance applications. Employing the more numerous corps of case managers would help to alleviate this backlog.

Other problems arise from the fact that insurance underwriters typically use printed copies of the guidelines to decide whether to order supplemental medical information. The guidelines are frequently modified and updated by the insurer, and with multiple copies of the guidelines existing in various locations, there is a risk that an insurance underwriter will use an outdated set of guidelines.

Due to these and other problems, there is a need for improving the ability to accurately, quickly, and inexpensively evaluate the medical history of patients to whom insurance may be extended or whose insurance rates are to be adjusted.

### BRIEF SUMMARY OF THE INVENTION

The present invention overcomes the problems noted above, and provides additional advantages, by employing a method and system of determining whether to request supplemental medical information about a patient. The method comprises the steps of receiving from a user patient information; determining, based on the patient information and its relation to a set of guidelines, whether to request supplemental medical information; and displaying to the user results that include the determination.

In another aspect, a system for assisting in determining whether to request supplemental medical information about a patient is provided. The system comprises at least one server computer; a plurality of client computers, each of the client computers being associated with a user, the plurality of client computers being connected to the at least one server computer over a computer network; wherein the at least one server computer incorporates at least one computer-readable medium including a first set of one or more instructions for receiving patient information from a user, the one or more instructions for determining, based on the patient information and its relation to a set of guidelines, whether to request supplemental medical information, and a second set of one or more instructions for displaying results that include the determination to the user.

In the system of the present invention, a server computer, preferably associated with an insurer, hosts a web site that displays to a case manager information regarding the insurer's policies for ordering supplemental medical information about a patient. Generally speaking, the system receives information about the patient in question from the case manager. The system compares the received patient information with the insurer's most current set of supplemental medical information ordering guidelines and then determines whether to order supplemental medical information. The system then informs the case manager whether supplemental medical information should be ordered. In addition, or as an alternative, the system can provide the case manager with a searchable listing of the insurer's guidelines, which the case manager can use to make the decision of whether to order supplemental medical information.

The system can also contain various quality-control features. One such feature could be an ability to update the guidelines or procedures on a system-wide basis, which would effectively preclude users from applying outdated guidelines or procedures. Another quality-control feature would be to teach the case manager how to use the system and implement the insurer's policies by conducting a tutorial program. Yet another feature would be to periodically administer a refresher test to the case manager to ensure that the case manager understands how properly to use the system. The system could be designed to automatically inform the case manager's supervisor about the case manager's performance on the refresher test, which would provide motivation to perform well and also assist with overseeing the performance of the system users. The system could also automatically create one or more checksheets that determine whether the case manager has followed all of the necessary procedural steps. Either the system or the user could fill out the checksheet, which, for example, could indicate whether all of the necessary procedural steps have been taken in processing the patient's information.

The system could also have various user-assistance features. One such feature could be an ability to direct a plurality of questions to a system administrator. Another feature could be to provide a list of frequently asked questions and answers that provide users with answers to basic questions. Yet another feature would be the ability to view various databases containing reference material about how to use the system, the guidelines, and the procedures.

### BRIEF DESCRIPTION OF THE DRAWINGS

The present invention can be understood more completely by reading the following Detailed Description of exemplary embodiments, in conjunction with the accompanying drawings, in which:

FIG. 1 is a block diagram of a computer network suitable for implementing a method and system according to an embodiment of the present invention;

FIG. 2 is a flow chart illustrating the steps conducted in one embodiment of a method for determining when to order supplemental medical information about a patient over the network of FIG. 1;

FIG. 3 is a flow chart describing the steps conducted in one embodiment of a method for generating a checksheet that indicates whether to order supplemental medical information about a patient;

FIG. 4 is a flow chart describing the steps conducted in one embodiment of a method for administering a tutorial to a system user;

FIG. 5 is a flow chart describing the steps conducted in one embodiment of a method for administering a tutorial using an iterative testing program;

FIG. 6 is a drawing depicting one embodiment of a method for administering a tutorial to a system user;

FIG. 7 is a flow chart describing the steps conducted in one embodiment of a method for administering a refresher test to a user;

FIG. 8 is a flow chart describing the steps conducted in one embodiment of a method for qualifying a system user to use the system;

FIG. 9 is a flow chart describing the steps conducted in one embodiment of a method for qualifying a system user by implementing tutorials and refresher tests.

### DETAILED DESCRIPTION OF THE INVENTION

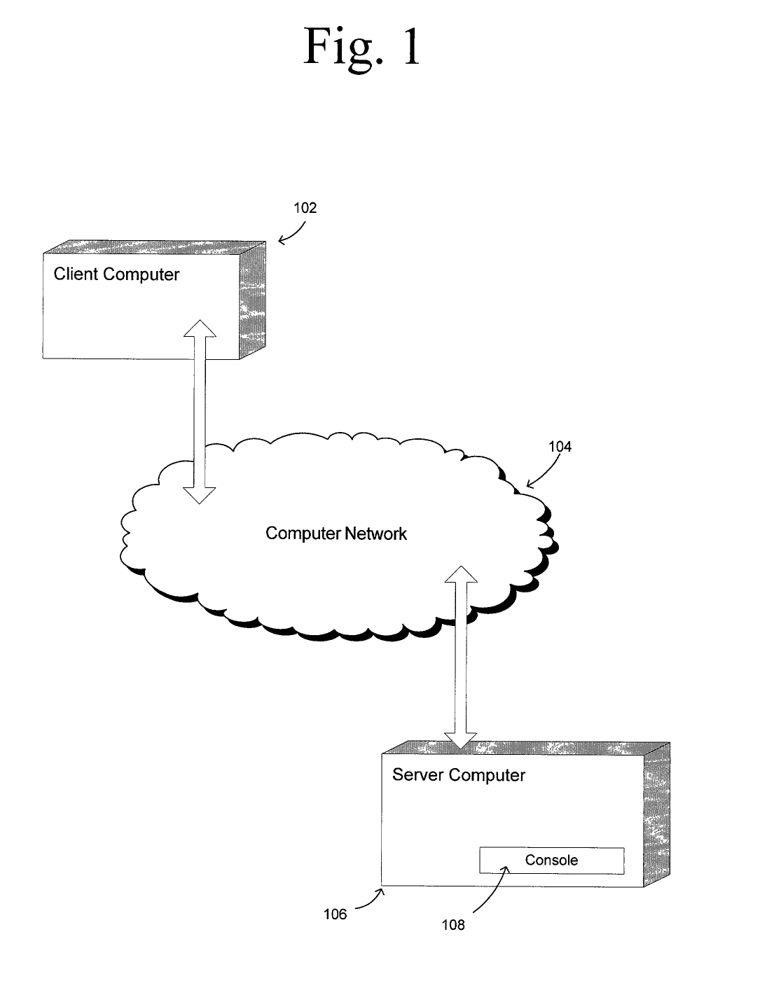

An Internet computer system is generally illustrated in FIG. 1. A conventional client computer system 102, executing a client browser application that supports the hypertext transfer protocol (HTTP), is connected typically through a network service provider to a suitable computer network 104 such as the Internet.

The client computer system 102 may include, for instance, a personal computer running a Microsoft Windows™ 95 operating system, a Microsoft Windows™ 98 operating system, a Millenium™ operating system, a Microsoft Windows™ NT™ operating system, a Microsoft Windows™ 2000 operating system, a Windows™ CE™ operating system, a PalmOS™ operating system, a Unix operating system, a Linux operating system, a Solaris™ operating system, an OS/2™ operating system, a BeOS TM operating system, a MacOS™ operating system or other operating system or platform. The client computer system 102 may also include a microprocessor such as an Intel x86-based device, a Motorola 68K device, a PowerPC™ device, a MIPS device, a Hewlett-Packard Precision™ device, or a Digital Equipment Corporation Alpha™ RISC processor, a microcontroller or another general or special purpose device operating under programmed control. Furthermore, the client computer system 102 may include an electronic memory such as a random access memory (RAM) or an electronically programmable read only memory (EPROM), a storage device such as a hard drive, a CDROM or a rewritable CDROM or another magnetic, optical or other media, and other associated components connected over an electronic bus, as will be appreciated by persons skilled in the art. The client computer system 102 may also include a network-enabled appliance such as a WebTV™ unit, a radio-enabled Palm™ Pilot, a networkable game-playing console such as a Sony Playstation™ or a Sega Dreamcast™ station, a browser-equipped cellular telephone, or another TCP/IP client or other device.

In addition to the Internet, the suitable computer network 104 may also include or interface with any one or more of a local intranet, a Personal Area Network (PAN), a Local Area Network (LAN), a Wide Area Network (WAN), a Metropolitan Area Network (MAN), a storage area network (SAN), a virtual private network (VPN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, or an Fiber Distributed Data Interface (FDDI) or a Copper Distributed Data Interface (CDDI) connection. Furthermore, the computer network 104 may also include links to any of a variety of wireless networks, including a Wireless Application Protocol (WAP), a General Packet Radio Service (GPRS), a Global System for Mobile Communication (GSM), a Code Division Multiple Access (CDMS) or a Time Division Multiple Access (TDMA), a cellular phone network, a Global Positioning System (GPS), a cellular digital packet data (CDPD), a Research in Motion, Limited (RIM) duplex paging network, a Bluetooth radio, or an IEEE 802.11-based radio frequency network. The computer network 104 may further include or interface with any one or more of an RS-232 serial connection, an IEEE-1394 Firewire connection, a Fibre Channel connection, an infrared (IrDA) port, a Small Computer Systems Interface (SCSI) connection, a Universal Serial Bus (USB) connection or another wired or wireless, digital or analog interface or connection.

A server computer system 106 is also typically coupled through an Internet Service Provider to the computer network 104. The server computer system 106 may include a workstation running a Microsoft Windows™ NT™ operating system, a Microsoft Windows™ 2000 operating system, a Unix operating system, a Linux operating system, a Xenix operating system, an IBM AIX™ operating system, a Hewlett-Packard UX™ operating system, a Novell Netware™ operating system, a Sun Microsystems Solaris™ operating system, an OS/2™ operating system, a BeOS™ operating system, a MacIntosh operating system, an Apache operating system, an OpenStep™ operating system or another operating system or platform. The server computer system 106, controlled by a local console 108, executes at least one web computer-readable medium conventionally known as a HTTP server. In addition, the server computer system 106 preferably provides local storage for at least one, though typically many, web pages. Also, the server computer system 106 may include several individual server computers at various locations on the network.

The client computer system 102 requests a web page by issuing a URL request through the computer network 104 to the server system 106. A URL consistent with the present invention may be a simple URL of the form:

<protocol_identifier>://<server_path>/<web_page path>

A “protocol_identifier” of “http” specifies the conventional hyper-text transfer protocol. A URL request for a secure Internet communication session typically utilizes a secure protocol identifier “https,” assuming that the client browser and web server each support and implement the secure sockets layer (SSL). The “server_path” is typically of the form “prefix.domain,” where the prefix is typically “www” to designate a web server and the “domain” is the standard Internet sub-domain.top-level-domain of the server computer system 106. The optional “web_page_path” is provided to specifically identify a particular hypertext page maintained by the web server.

In response to a received URL identifying an existing web page, the server computer system 106 returns the web page, subject to the HTTP protocol, to the client computer system 102. This web page typically incorporates both textual and graphical information including embedded hyper-text links, commonly referred to as hyperlinks, or links, that permit the client user to readily select a next URL for issuance to the computer network 104.

The URL issued from the client computer system 102 may also be of a complex form that identifies a common gateway interface (CGI) program on a server computer system 106. Such a HTML hyperlink reference is typically of the form:

<form action=“http://www.vendor.com/cgi-bin/logon.cgi” method=post>

A hyper-text link of this form directs the execution of the logon.cgi program on an HTTP server in response to a client-side selection of the hyperlink. A logon form supported by a logon CGI program is typically used to obtain a client user login name and password to initiate an authenticated session between the client browser and web server for purposes of supporting, for example, a secure purchase transaction or a secure communications session.

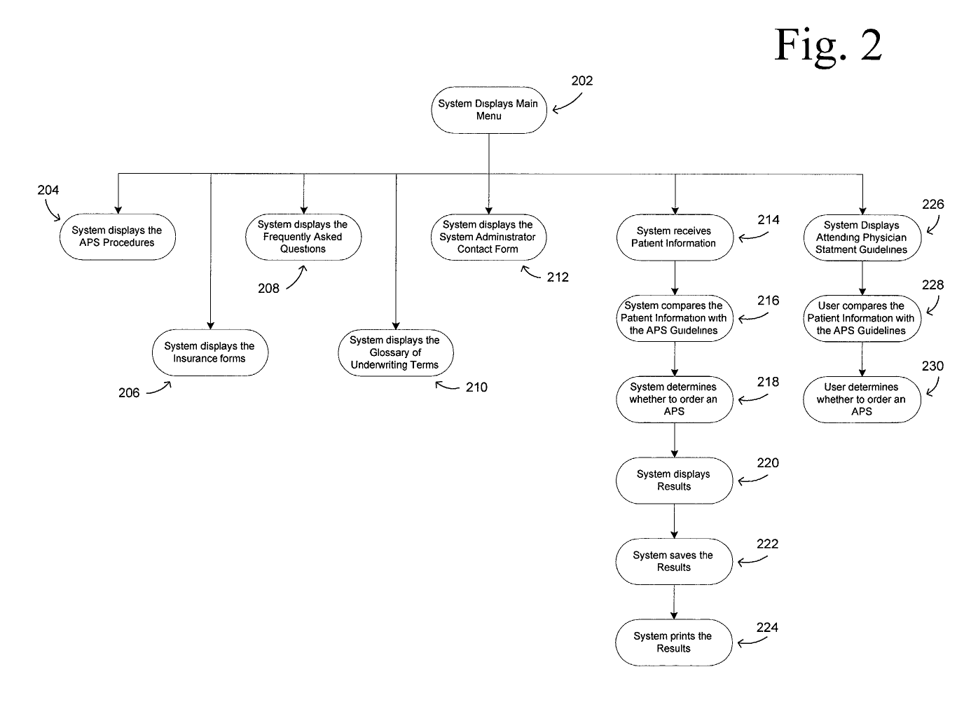

Referring now to FIG. 2, there is shown a flow chart illustrating the steps performed in one embodiment of a method for determining when to order supplemental medical information about a patient over the network of FIG. 1 above. Preferably, the method and system described below is implemented by a computer software program, such as a web server application, resident on one or more server computers (such as the server computer system 106, described above) associated with an insurer. Preferably, such a web server application includes a computer-readable medium utilized to create and maintain a plurality of dynamically interactive web pages on the server computers. In a preferred embodiment, users of the system are connected to the insurer's web pages through a plurality of client computers (such as the client computer system 102) over the computer network 104. In this manner, users may remotely interact with the server computer system 106 to obtain, exchange, or modify information as more fully set forth in detail below.

Although not limited thereto, computer software programs for implementing the present method may be written in any number of suitable programming languages such as, for example, a Hypertext Markup Language (HTML), a Dynamic HTML language, an Extensible Markup Language (XML), an Extensible Stylesheet Language (XSL), a Document Style Semantics and Specification Language (DSSSL), a Cascading Style Sheets (CSS) language, a Synchronized Multimedia Integration Language (SMIL), a Wireless Markup Language (WML), a JavaTm language, a Jini™ language, a C language, a C++ language, a Perl language, a UNIX Shell language, a Visual Basic or Visual Basic Script language, a Virtual Reality Markup Language (VRML), a ColdFusion™ language or another compiler, assembler, interpreter or other computer language or platform.

FIG. 2 depicts a preferred embodiment of a method pursuant to which a user can determine whether to order an Attending Physician Statement and with which the user can access various other features of the system that will help the user operate the system. At step 202, the system displays a main menu to the user, from which the user can select various options. The main menu can be in the form of a Home Page, which, as it is known in the art, is generally a first page of a web site, or a collection of related web pages, and provides a starting point for enabling a user to navigate through the web site in an orderly, user-friendly manner.

In a preferred embodiment, the options presented on the Home Page, known in the art as links, as described in more detail above, are designed to help the user operate the system. The user can move between the various links and return to the Home Page from any of the links. In one embodiment of the present invention, one option is to branch to a link 204 that will instruct the system to display the Attending Physician Statement Procedures, which are described in more detail above. Another option is to branch to a link 206 to view one or more Insurance Forms. These Insurance Forms can be blank, or they can be digitally stored versions of forms completed by the specific patient being analyzed. A third option is to branch to a link 208 to view a plurality of Frequently Asked Questions, which is known in the art as a display of common questions about the system and the answers to those questions. A fourth option is to branch to a link 210 to display a Glossary of Underwriting Terms, which is especially useful if the user is not an underwriter. A fifth option is to branch to a link 212 to contact the system administrator, which is useful for informing the system administrator of any problems with the system.

Another option on the main menu in a preferred embodiment is to branch to a link 214 enter patient information into the system. Once the system has received the entered patient information, at step 216, the system compares the entered patient information with a plurality of guidelines, which are more fully described above. Based on this comparative analysis, at step 218, the system determines whether to order supplemental medical information, as described above, and, at step 220, displays the results to the user. At step 222, the user can then instruct the system to save the results in a storage medium. It is envisioned that the system could use a variety of storage media to save the results, including, but not limited to, magnetic storage on hard drives, floppy discs, and magnetic tape, and optical storage on compact discs and optical tape. At step 224, the system is also able to print the results, upon the user's request, to local or remote printers.

A final option on the main menu in a preferred embodiment is to branch to a link 226 to display the guidelines to the user, and then at step 228, to allow the user to compare the entered patient information with the guidelines so that the user can then, at step 230, determine whether to order supplemental medical information. In one embodiment, the system provides a comprehensive list of all of the guidelines. As stated before, each guideline corresponds to a medical condition and states whether supplemental medical information should be ordered for that condition. The user examines each of the patient's medical conditions and compares it with the list of guidelines to determine whether to order supplemental medical information. It is anticipated that the guidelines could be organized to facilitate quick browsing. In one exemplary embodiment, the comprehensive list is sorted by subject matter to facilitate quick browsing. In another exemplary embodiment, the comprehensive list is content-searchable, so that a user can search for particular guidelines that contain user-entered words or phrases. In yet another exemplary embodiment, the comprehensive list of guidelines is sorted by frequency, so that the most frequently used guidelines are displayed more prominently. Other methods for organizing the guidelines are also anticipated.

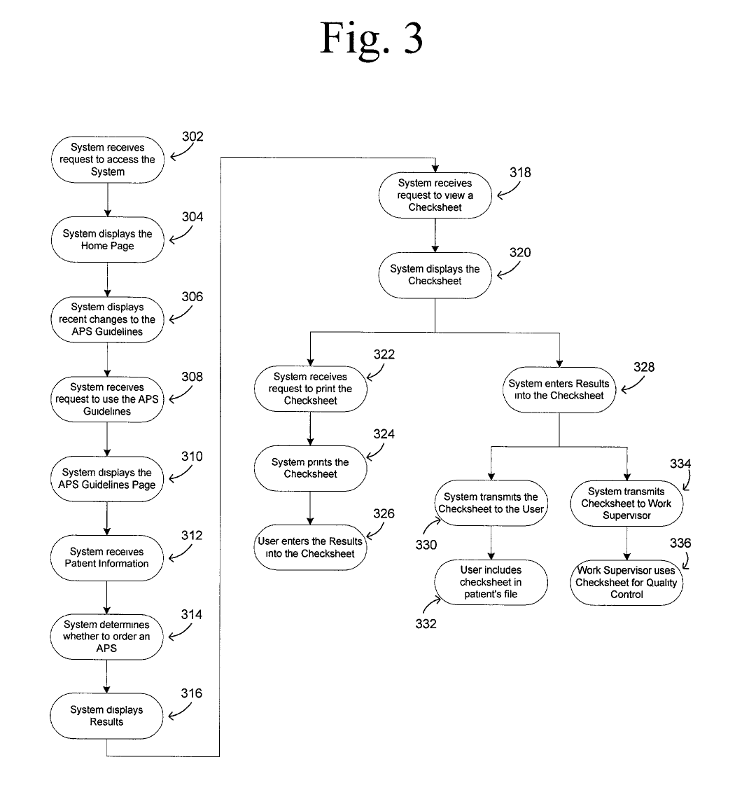

FIG. 3 depicts the steps performed in an embodiment of the invention in which the system displays recent changes to the guidelines, determines whether to order supplemental medical information, and generates output in the form of a checksheet that can be used for various purposes. In this embodiment, at step 302, the system receives a request to use the system, and, at step 304, displays the system Home Page, and, at step 306, also displays any recent changes to the guidelines. The step 306 of displaying recent changes to the guidelines helps to ensure that the users are knowledgeable about the current version of the system. These changes can be displayed in a variety of ways. In one embodiment, the changes are displayed in the text of the Home Page itself. In another embodiment, the changes are displayed in what is known in the art as a Pop-up Window, which is a display window that is automatically opened on the viewing screen according to the system's directions. In an embodiment utilizing a Pop-up Window, the system can prevent use of the Home Page until the user has closed the Pop-up window, which provides some assurance that the user has reviewed the changes to the guidelines.

Once the system has displayed the recent changes to the guidelines in step 306, at step 308, the system receives a request to use the guidelines, and, at step 310, displays the guidelines page. In a preferred embodiment, at step 312, the user then enters patient information into the system. Based on the entered patient information, at step 314, the system determines whether to order supplemental medical information, and, at step 316, displays the results to the user. In another embodiment, the user can view the guidelines and make his or her own decision whether to order supplemental medical information. At step 318, the system receives a request to view a checksheet and, at step 320, displays the checksheet to the user. The checksheet is a form that identifies the patient and indicates whether supplemental medical information should be ordered for that patient. In a preferred embodiment, the checksheet contains a plurality of fields for the patient's policy number, the case manager's identification, the determination of whether to order supplemental medical information, and the reason why supplemental medical information should be ordered. Other embodiments of the invention could include different or additional fields that would improve the usefulness of the checksheet.

In a preferred embodiment, the user would have the choice of utilizing the checksheet in either paper or electronic format. In another embodiment the system would automatically determine whether the user should use electronic or paper format based upon previously designated user preferences stored in a user profile. If the user elects to proceed in paper format, at step 322, the user requests a printed version of the blank checksheet, which the system prints at step 324. At step 326, he user enters the results of the determination of whether to order supplemental medical information into the checksheet after the checksheet is printed at step 324. The user can enter the results into the checksheet by any number of means, including hand writing, typing, or printing with a conventional computer printer or its equivalent.

If the user elects to proceed in electronic format, at step 328, the user enters the results of the determination directly into the blank fields of the checksheet that has been displayed by the system at step 320. Although in this embodiment the user enters the results into the checksheet, it is also anticipated that the system could automatically populate some or all of the fields of the checksheet based upon the patient information entered by the user and the system's determination of whether to order supplemental medical information, so that when the user requests a display of a checksheet, the checksheet is already partly or fully completed. In a preferred embodiment, once the user completes the checksheet, at step 330, the system transmits the checksheet to the user in electronic format for the user to include in the patient's file at step 332. In one embodiment, the system also automatically transmits the completed checksheet to a work supervisor in step 334. And, in step 336, the work supervisor uses the checksheet for quality control, auditing, and other purposes.

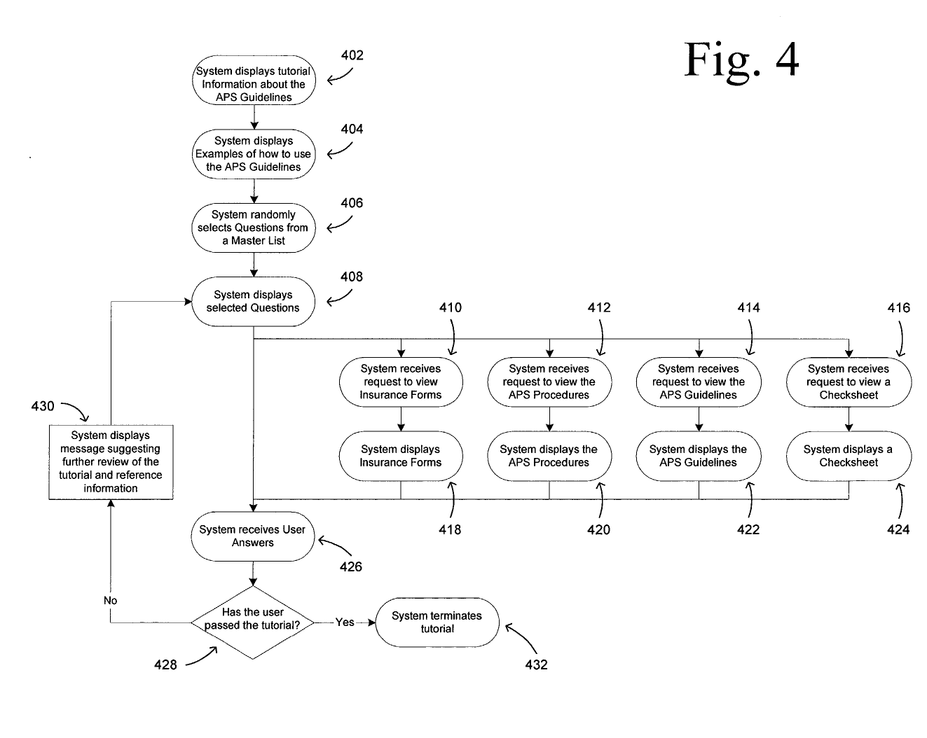

FIG. 4 depicts the steps conducted in a preferred embodiment in which the system administers a tutorial to the user. In this embodiment of the invention, the tutorial has features that enable the user to learn how to use the system and is designed to ensure that the user does not proceed to use the system without adequately learning how to use the system. At the beginning of the tutorial, in step 402, the system displays tutorial information concerning use of the system. In a preferred embodiment, the tutorial information includes information about the guidelines and procedures for ordering supplemental medical information, but it is anticipated that the tutorial information can contain any information related to using the system. In addition to displaying the tutorial information, in step 404, the system displays examples of how to use the system. In one embodiment, the system randomly selects questions about the system from a master list of questions at step 406, and displays the selected questions to the user at step 408. A master list of questions is maintained by a system administrator, who can change the questions. In another embodiment, the system asks the selected questions according to a predetermined schedule, instead of randomly. In a preferred embodiment, the tutorial information, the examples, and the selected questions are each displayed in a different frame of the same web page. A frame, as it is known in the art, is a distinct portion of a web page that can be manipulated independent of the other portions. Thus, for example, the user could examine the questions in one frame, and, at the same time, scroll through the tutorial information in a different frame.

In a preferred embodiment, during the tutorial, the user can access reference information, other than the tutorial information and the examples, that will assist the user in answering the tutorial questions. In a preferred embodiment the user can request to view insurance forms at step 410, can request to view a list of procedures at step 412, can request to view a list of guidelines at step 414, or can request to view a checksheet at step 416. Upon the user's request for any of these references, the system will display insurance forms at step 418, will display the list of procedures at step 420, will display the list of guidelines at step 422, or will display the checksheet at step 426. The system can display the reference information in a multitude of ways. In one embodiment, the reference information is displayed in a pop-up window, as previously described. In another embodiment, the reference information is displayed in a frame of the same web page, as previously described. In a third embodiment, the reference information is displayed in a separate web page. Other display methods are also anticipated. From each of these display options, the user can select any of the other viewing options, or can return to view the tutorial information. The user can also proceed to answer the questions without viewing the reference information.

Once the user has viewed all of the material that the user thinks is necessary to prepare to answer the questions, the system receives the user's answers at step 426, and determines whether the user has correctly answered enough questions to pass the tutorial at step 428. If the user does not pass the tutorial, at step 430, the system displays a message suggesting further review of the tutorial information and reference information and redisplays the same questions at step 408. In another embodiment, if the user does not pass the tutorial, the system randomly selects a new set of questions to display to the user at step 406. In yet another embodiment, the system analyzes which questions the user answered incorrectly using an algorithm, and selects new questions based on this algorithm. For example, the system could ask questions closely related to those that the user incorrectly answered, to ensure that the user knows the information related to that type of question.

If the user passes the tutorial, then at step 432, the system terminates the tutorial and returns the user to the main menu.

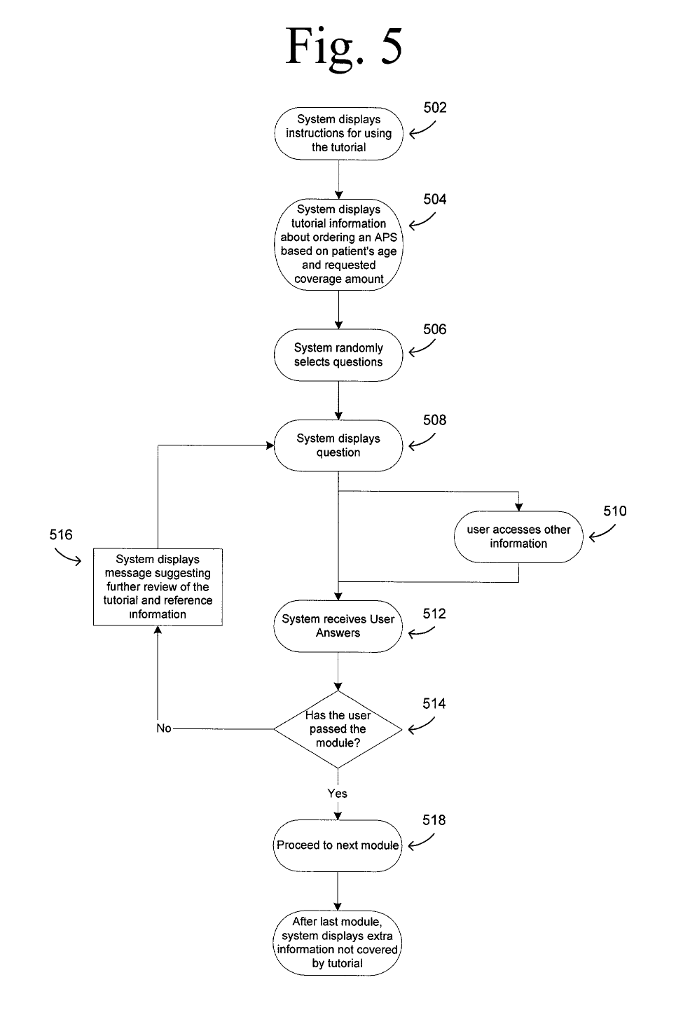

FIG. 5 is a flowchart illustrating the steps conducted in a preferred embodiment of an iterative testing routine that can be used to administer the tutorial, described above, to a user. The tutorial begins by displaying instructions on using the tutorial at step 502. Next, the system begins a series of iterative testing modules. In each testing module, the system tests the user on a discrete subject matter. In a preferred embodiment, there are three subject matters: (1) whether to order supplemental medical information based on the patient's age and the requested amount of insurance coverage, (2) whether to order supplemental medical information based on the patient's physical build, and (3) whether to order supplemental medical information based on the patient's other medical conditions. It is anticipated that the iterative testing modules can be comprised of subject matters other than those in the preferred embodiment as stated above.

In the first iterative testing module, at step 504, the system displays information and examples about ordering supplemental medical information based on the patient's age and the requested coverage amount. At step 506, the system then randomly selects questions about ordering supplemental medical information based on the patient's age and the requested coverage amount and, at step 508, displays these questions to the user. In a preferred embodiment, more fully described above, at step 510, the user can access reference information, other than the tutorial information and the examples, which will assist the user in answering the tutorial questions. At step 512, the user enters his answers into the system, and, at step 514, the system determines whether the user has passed the first testing module by correctly answering the required number of questions.

If the user has not passed the first iterative testing module, at step 516, the system displays a message instructing the user to review the tutorial information and reference information, and, at step 508, redisplays the tutorial questions. If the user has correctly answered the requisite number of tutorial questions, the system moves on to the next iterative testing module at step 518 and repeats the process described above until the user successfully completes the final iterative testing module. Once the user successfully completes the final iterative testing module, at step 520, the system displays any extra information, not included in the tutorial information, that the system administrator determines is necessary for the user to have a complete understanding of the system. This ensures that the user has seen all of the instructions for using the system at least once. After the extra information is displayed, the system terminates the tutorial and returns the user to the main menu.

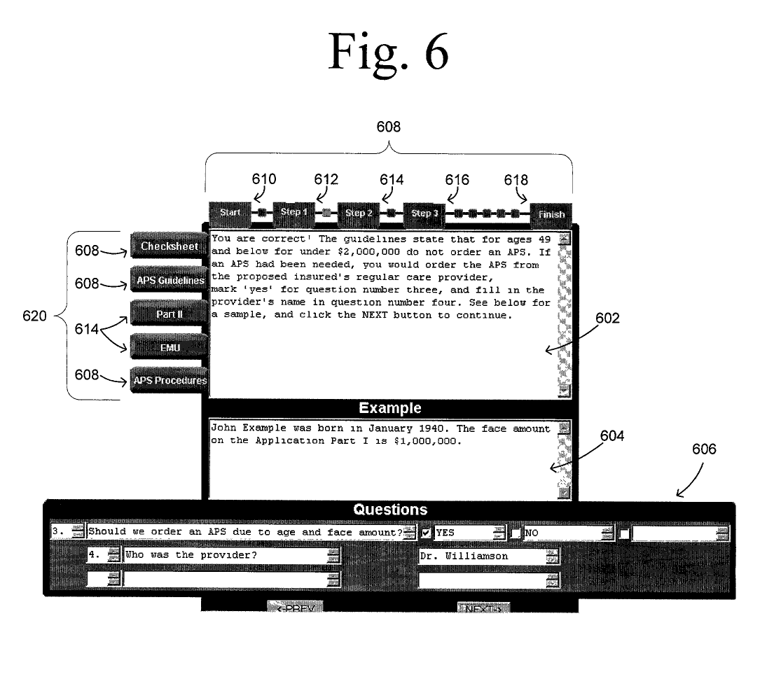

FIG. 6 depicts a user interface for administering an iterative testing routine tutorial to a user. In this preferred embodiment, the user interface has three information fields, although it is anticipated that an embodiment of the user interface could have any number of information fields. The first information field is a text field 602, the second information field is an example field 604, and the third information field is a question and answer field 606.

The user interface also contains a plurality of step indicators 608, which indicate how far the user has progressed in the iterative testing routine tutorial. In a preferred embodiment, the user interface displays all of the step indicators, and a current step is distinguished by graphically highlighting that current step's step indicator in the interface. In the depicted preferred embodiment, a first step is a start step, which is displayed by highlighting a start step indicator 610. The next step is step 1, which is indicated by highlighting a step 1 indicator 612. Step 2 is indicated by highlighting a step 2 indicator 614, and step 3 is indicated by highlighting a step 3 indicator 616. At the completion of the tutorial, a finish step indicator 618 is highlighted. In another preferred embodiment, only the step indicator of the current step would be displayed to the user.

In a preferred embodiment, the contents of the text field 602 vary with each step. During the start step, the text field 602 displays instructions on using the tutorial. In step 1, the text field 602 initially displays tutorial information about ordering supplemental medical information based on the patient's age and the requested amount of insurance coverage. In step 2, the text field 602 initially displays tutorial information about ordering supplemental medical information based on the patient's physical build. In step 3, the text field 602 initially displays tutorial information about ordering supplemental medical information based on the patient's medical condition. In the final step, the text field 602 displays a congratulatory message to the user indicating that the user has completed the iterative testing routine tutorial.

During step 1, step 2, and step 3, the example field 604 displays examples of using the system. In step 1, the example field 604 displays examples of ordering supplemental medical information based on the patient's age and the requested amount of insurance coverage. In step 2, the example field 604 displays examples of ordering supplemental medical information based on the patient's physical build. In step 3, the example field 602 displays examples of ordering supplemental medical information based on the patient's medical condition.

During step 1, step 2, and step 3, the question and answer field 606 displays questions about using the ordering procedures. In step 1, the question and answer field 604 displays questions about ordering supplemental medical information based on the patient's age and the requested amount of insurance coverage. In step 2, the question and answer field 604 displays questions about ordering supplemental medical information based on the patient's physical build. In step 3, the question and answer field 602 displays questions about ordering supplemental medical information based on the patient's medical condition. In each of the above mentioned steps, a set of empty fields is displayed in the question and answer field 604 into which the user enters answers.

Also depicted in FIG. 6 is a reference menu 620. In a preferred embodiment, when the user selects a reference from the reference menu 620, the system displays the contents of the selected reference in the text field 602, replacing whatever text was in the field before. The user can view the contents of each reference to assist the user in answering the tutorial questions, which remain displayed in the question and answer field 606. In another preferred embodiment, the system displays the contents of the selected reference in one or more Pop-up Windows. Once the user has finished viewing a reference, the user can select another reference from the reference menu 620, or can return to the tutorial information related to whatever step the user is currently in.

In one preferred embodiment, the reference menu 620 contains a plurality of links to view a checksheet 622, to view a plurality of guidelines 624, to view a plurality of Insurance Forms 626, and to view a plurality of procedures 628. It is envisioned that the reference menu 620 could contain any number of links to information that is useful for answering the questions. Alternatively, an embodiment can also not provide a reference menu, which could increase the difficulty of the tutorial.

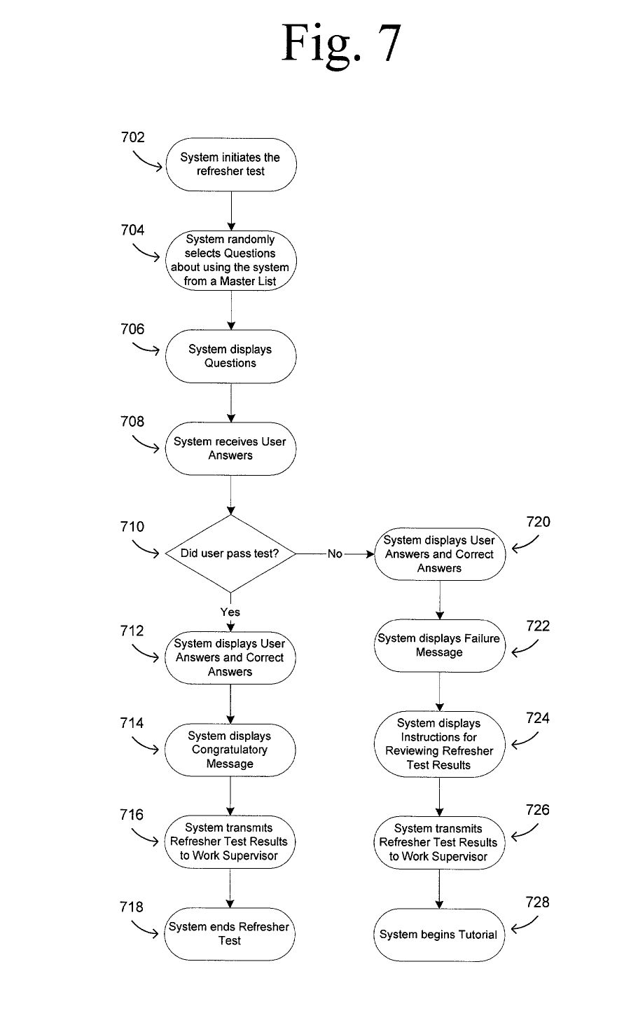

FIG. 7 depicts steps performed in an embodiment of a system which administers a refresher test to a user. A refresher test is a test that is administered to a user to ensure that the user is knowledgeable and skilled enough to continue to use the system. In a preferred embodiment, the refresher test is periodically administered, however, the refresher could be administered at random times. In another embodiment, refresher test is administered upon the user's request. These embodiments could be combined with an embodiment that administers tutorials to users, as described above. In one embodiment, the system initiates a refresher test at step 702, during which the user is unable to access other parts of the system, so that the user cannot use reference materials to assist with answering the questions. In another embodiment the user would be able to view reference materials, as described in detail above, to assist with answering the questions.

In a preferred embodiment, at step 704, the system randomly selects questions about the system from a master list of questions and then, at step 706, the system displays the questions to the user. The master list of questions can be changed by the system administrator. In another embodiment, the refresher test uses a fixed set of questions that can be changed by the system administrator. At step 708, the system receives the user's answers, and then, at step 710, determines whether the user has correctly answered the requisite number of questions to pass the refresher test.

If the user has passed the test, at step 712, the system displays the user's answers and the correct test answers so that the user can see which questions, if any, the user did not correctly answer, and see the correct answers to those questions. In one embodiment, the system also displays a congratulatory message at step 714, at step 716, transmits the test results to the user's work supervisor, and, at step 718, terminates the refresher test.

If the user has failed the refresher test, at step 720, the system displays the user's answers and the correct test answers so that the user can see which questions the user did not correctly answer, and see the correct answers to those questions. At step 722, he system also displays a message indicating that the user has not passed the test. In one embodiment, at step 724, the system displays instructions for the user to follow to review the user's test results with a work supervisor, and, at step 726, transmits the test results to the user's work supervisor. In a preferred embodiment, at step 728, the system administers a tutorial, as described more fully above, to a user who does not pass the refresher test.

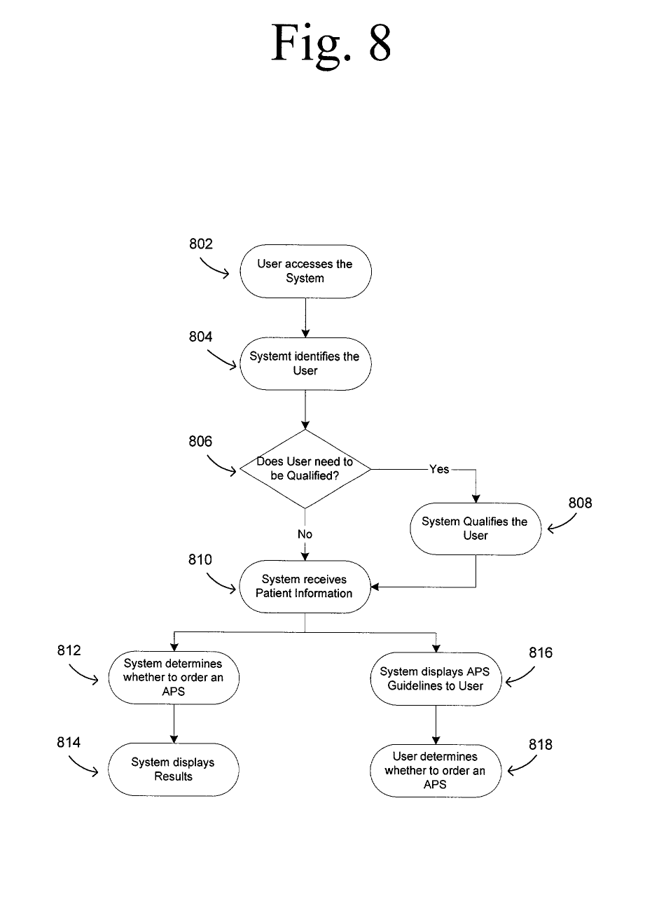

FIG. 8 depicts the steps performed in one embodiment of a method for qualifying a system user to use the system. It is desirable to ensure that system users have the requisite amount of knowledge and skill to properly use the system, to this end, in a preferred embodiment of the system, the system will qualify the user. In a preferred embodiment, the system administers a tutorial to first-time users and then periodically administers refresher tests to the user. One advantage of this preferred embodiment is that it will allow users with relatively little knowledge to quickly learn how to use the system. Another advantage is that the present preferred embodiment will ensure that the users maintain his or her knowledge and skills.

When the user accesses the system in step 802, at step 804, the system identifies the user. The system can identify the user in a number of ways. For example, in one embodiment, the user enters personal identification information, which may include a user code and a password, to access the system. As another example, in another embodiment, the system polls the user's computer terminal to identify the user associated with that terminal. At step 806, the system then determines whether the user is qualified or whether the user needs to be qualified. If the user needs to be qualified, the system undergoes whatever steps are necessary, such as administering the aforementioned tutorial and refresher test, to qualify the user at step 808.

After the system qualifies the user, or if the system determines that the system does not need to qualify the user at this time, the system will then receive patient information at step 810, determine whether to order supplemental medical information at step 812, and display the results to the user at step 814.

In another embodiment, after the system qualifies the user, or if the system determines that the user is already qualified, the system would then display the guidelines to the user at step 816 so that the user could determine whether to order supplemental medical information in step 818.

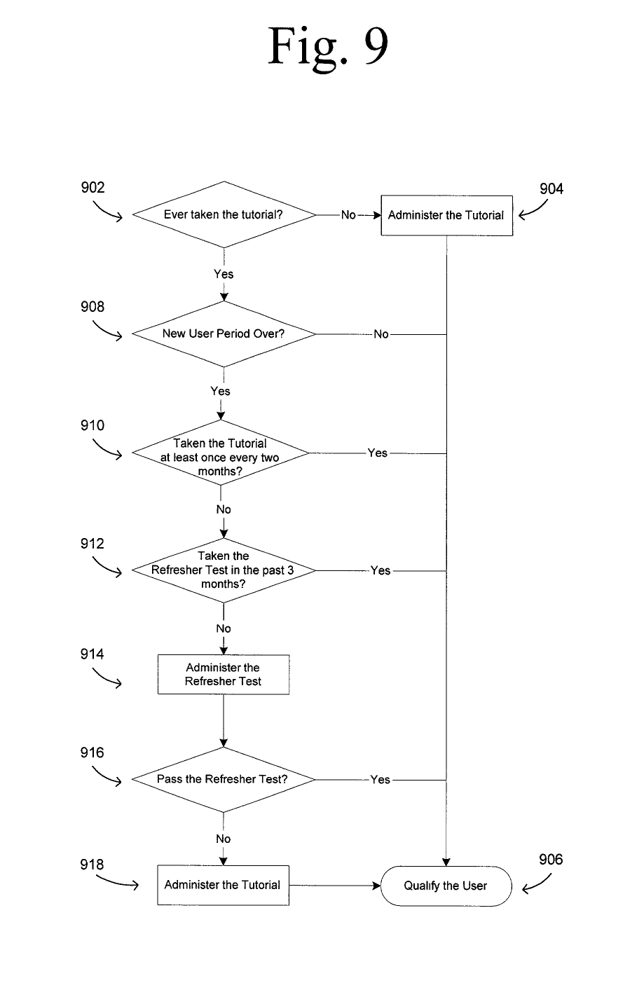

FIG. 9 is a flow chart depicting the steps performed in an embodiment of a method for qualifying a system user by implementing tutorials and refresher tests. The qualification process begins by determining whether the user has ever been administered a tutorial of step 902. In a preferred embodiment, the user is administered a tutorial upon first using the system, so in this embodiment, a user who has never taken the tutorial would correspond to a user who has never used the system. Although it is anticipated that the qualification feature of the system would be present when the system initially goes into service, the qualification system could also be added to an existing system. In this case, a person who has never taken the tutorial could be a person who has used the system before. In either case, if the user has never taken the tutorial, the system administers the tutorial to the user at step 904. Upon completion of the tutorial, at step 906, the system qualifies the user to use the system.

In a preferred embodiment, if the user has taken the tutorial, then, at step 908, the system determines whether a new user period is over. The new user period is a period of time after the user takes the tutorial for the first time. The length of the new user period is determined by the system administrator, and preferably corresponds to the amount of time that a new user will be able to use the system without losing a significant amount of the knowledge and skills obtained by taking the tutorial. In a preferred embodiment, the new user period is three months. If the system determines that the new user period is not over, then, in step 906, the system qualifies the user to use the system.

If the system determines that the new user period is over, then, in step 910, the system determines whether the user has taken the tutorial with a predetermined exemption frequency that is specified by the system administrator. If the user voluntarily takes the tutorial often enough, then, presumably, he will not forget the knowledge and skills taught in the tutorial, and will not be required to take a refresher test. In a preferred embodiment, the predetermined exemption frequency is at least once every two months. If the user has taken the tutorial with the predetermined exemption frequency, then the system qualifies the user to use the system at step 906.

If the user has not taken the tutorial with the predetermined exemption frequency, then the system determines whether the user has recently taken a refresher test in step 912. The refresher test is administered to users who have gone for a period of time without taking any sort of test or tutorial to refresh the user's knowledge and skill at using the system. In a preferred embodiment, the system establishes a periodic testing schedule for the user. If the user does not take the tutorial with the predetermined exemption frequency, then the user is required to pass refresher tests administered according to the periodic testing schedule. In a preferred embodiment, the system establishes a periodic testing schedule of once every three months. If the user has recently taken a refresher test the system qualifies the user to use the system in step 906.

If the user has not recently taken a refresher test, the system administers a refresher test to the user at step 914, as is more fully described above. If the user passes the refresher test, the system qualifies the user to use the system in step 906.

If the user fails the refresher test, then the system administers the tutorial to the user in step 918, and, at the conclusion of the tutorial, the system qualifies the user to use the system in step 906.

While the foregoing method includes both a tutorial and a refresher test, it is anticipated that embodiments of the current invention could include only a periodically administered tutorial or a periodically administered refresher test.

By providing a method and system for assisting in determining when to order supplemental medical information about a patient, the present invention enables an insurer to save money, improve efficiency, and speed up its current administrative procedures. A greater number of lower-paid individuals can implement an insurer's policies regarding ordering supplemental medical information, reducing cost and increasing speed. Furthermore, by implementing tutoring and testing methods the present invention allows these users to implement the insurer's policies with greater speed and accuracy than was heretofore possible. The present invention also facilitates review of the users' performance, and auditing of the system.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

We claim:

1. A method of determining whether to request supplemental medical information about a patient, comprising the steps of:
receiving from a user patient information;
determining, based on said patient information and its relation to a set of guidelines, whether to request supplemental medical information; and
displaying to said user results that include the determination.

2. The method of claim 1, wherein said step of receiving patient information is comprised of the step of:
receiving information about the patient's age, physical build, medical history, and the requested amount of insurance coverage.

3. The method of claim 1, further comprising the steps of:
changing said set of guidelines; and
storing in an archive changes made to said set of guidelines.

4. The method of claim 3, further comprising the step of:
displaying the changed guidelines to said user.

5. The method of claim 1, further comprising the steps of:
storing said results in a storage medium; and
printing said results.

6. The method of claim 1, further comprising the steps of:
receiving a user request to contact a system administrator;
displaying to said user a contact form;
receiving input from said user; and
sending said input to said system administrator.

7. The method of claim 1, further comprising the steps of:
receiving a user request to view reference information; and
displaying said reference information to said user.

8. The method of claim 7, wherein said step of displaying reference information is comprised of the steps of:
displaying to said user said set of guidelines;
displaying to said user a plurality of procedures for determining when to order supplemental medical information about a patient;
displaying to said user a glossary of underwriting terms;
displaying to said user a plurality of insurance forms;
displaying to said user a set of Frequently Asked Questions.

9. The method of claim 1, further comprising the step of:
displaying to said user a checksheet.

10. The method of claim 9, further comprising the steps of:
receiving user input relating to a patient; and
displaying said received user input on said checksheet.

11. The method of claim 9, further comprising the step of:
storing said checksheet in a storage medium.

12. The method of claim 9, further comprising the step of:
printing said checksheet.

13. The method of claim 1, further comprising the step of:
administering a tutorial to said user.

14. The method of claim 13, further comprising the steps of:
receiving a user request, during the tutorial, to view reference information; and
displaying said reference information to said user.

15. The method of claim 14, wherein the step of displaying reference information to said user is comprised of the steps of:
displaying to said user said plurality of insurance forms;
displaying to said user said set of guidelines;
displaying to said user a plurality of procedures; and
displaying to said user a checksheet.

16. The method of claim 13, wherein the said step of administering a tutorial is comprised of the steps of:
displaying to said user tutorial information;
displaying to said user a plurality of questions about said tutorial information;
receiving a user answer to each of said questions;
generating a tutorial test score based upon the questions and the answers; and
displaying to said user said tutorial test score.

17. The method of claim 16, wherein said tutorial test score is transmitted to a work supervisor.

18. The method of claim 16, further comprising the step of displaying to said user extra information at the end of the tutorial.

19. The method of claim 1, further comprising the step of:
administering a refresher test to said user.

20. The method of claim 19, wherein said step of administering a refresher test is comprised of the steps of:
displaying to said user a plurality of refresher questions;
receiving a user answer to each of said refresher questions;
generating a refresher test score based upon the questions and the answers; and
displaying to said user said refresher test score.

21. The method of claim 20, wherein said refresher test score is transmitted to a work supervisor.

22. The method of claim 1, further comprising the steps of:
receiving a user request to take a tutorial; and
administering said tutorial to said user.

23. The method of claim 1, further comprising the steps of:
receiving a user request to take a refresher test; and
administering said refresher test to said user.

24. The method of claim 2, further comprising the steps of:
changing said set of guidelines;
displaying changes made to said set of guidelines to said user;
storing changes made to said set of guidelines in an archive;
receiving a user request to view reference information;
displaying said reference information to said user;
storing said results in a storage medium;
printing said results;
displaying to said user a checksheet;
receiving user input;
displaying said user input on said checksheet;
storing said checksheet in a storage medium;
printing said checksheet;
administering a tutorial to said user; and
administering a refresher test to said user.

25. A method of determining whether to request supplemental medical information about a patient, comprising the steps of:
qualifying a user;
receiving from said user patient information;
determining, based on said patient information and its relation to a set of guidelines, whether to request supplemental medical information; and
displaying to said user results that include the determination.

26. The method of claim 25, wherein said step of receiving patient information is comprised of the step of:
receiving information about the patient's age, physical build, medical history, and the requested amount of insurance coverage.

27. The method of claim 25, further comprising the steps of:
changing said set of guidelines; and
storing in an archive changes made to said set of guidelines.

28. The method of claim 27, further comprising the step of:
displaying the said changes made to said set of guidelines to said user.

29. The method of claim 25, further comprising the steps of:
storing said results in a storage medium; and
printing said results.

30. The method of claim 25, further comprising the steps of:
receiving a user request to contact a system administrator;
displaying to said user a contact form;
receiving input from said user relating to a patient; and
sending said input to said system administrator.

31. The method of claim 25, further comprising the steps of:
receiving a user request to view reference information; and
displaying said reference information to said user.

32. The method of claim 31, wherein said step of displaying reference information is comprised of the steps of:
displaying to said user said set of guidelines;
displaying to said user a plurality of procedures;
displaying to said user a glossary of underwriting terms;
displaying to said user a plurality of insurance forms;
displaying to said user a set of Frequently Asked Questions.

33. The method of claim 25, further comprising the step of:
displaying to said user a checksheet.

34. The method of claim 33, further comprising the steps of:
receiving user input relating to a patient; and
displaying said user input on said checksheet.

35. The method of claim 33, further comprising the step of:
storing said checksheet in a storage medium.

36. The method of claim 33, further comprising the step of:
printing said checksheet.

37. The method of claim 25, further comprising the step of:
administering a tutorial to said user.

38. The method of claim 37, further comprising the steps of:
receiving a user request, during the tutorial, to view reference information; and
displaying said reference information to said user.

39. The method of claim 38, wherein the step of displaying reference information to said user is comprised of the steps of:
displaying to said user a plurality of insurance forms;
displaying to said user said set of guidelines;
displaying to said user a plurality of procedures; and
displaying to said user a checksheet.

40. The method of claim 37, wherein the said step of administering a tutorial is comprised of the steps of:
displaying to said user tutorial information;
displaying to said user a plurality of questions about said tutorial information;
receiving a user answer to each of said questions;
generating a tutorial test score based upon the questions and the answers; and
displaying to said user said tutorial test score.

41. The method of claim 40, wherein said tutorial test score is transmitted to a work supervisor.

42. The method of claim 40, further comprising the step of displaying to said user extra information at the end of the tutorial.

43. The method of claim 37, wherein said step of qualifying said user is comprised of the step of:
administering said tutorial to said user if it is determined that said user has never taken said tutorial.

44. The method of claim 43, further comprising the step of:
administering said tutorial to said user if it is determined that said user has not recently taken said tutorial.

45. The method of claim 44, further comprising the step of:
administering said tutorial to said user if it is determined that said user has not taken said tutorial in the past two months.

46. The method of claim 25, further comprising the step of:
administering a refresher test to said user.

47. The method of claim 46, wherein said step of administering a refresher test is comprised of the steps of:
displaying to said user a plurality of refresher questions;
receiving a user answer to each of said refresher questions;
generating a refresher test score based upon the questions and the answers; and
displaying to said user said refresher test score.

48. The method of claim 47, wherein said refresher test score is transmitted to a work supervisor.

49. The method of claim 46, wherein said step of qualifying said user is comprised of the steps of:
administering said refresher test to said user if it is determined that said user has not recently passed said refresher test; and
qualifying said user if said user passes said refresher test.

50. The method of claim 49, wherein said step of qualifying said user is comprised of the steps of:
administering said refresher test to said user if it is determined that said user has not passed said refresher test in the past three months; and
qualifying said user if said user passes said refresher test.

51. The method of claim 37, wherein said step of qualifying said user is comprised of the steps of:
administering said tutorial to said user if it is determined that said user has never taken said tutorial;
administering a refresher test to said user at periodic intervals if it is determined that a new user period has ended; and
administering said tutorial to said user after said refresher test if it is determined that said user has failed said refresher test.

52. The method of claim 37, further comprising the steps of:
receiving a user request to take said tutorial; and
administering said tutorial to said user if it is determined that said user has requested to take said tutorial.

53. The method of claim 52, wherein said step of qualifying said user is comprised of the steps of:
administering said tutorial to said user if it is determined that said user has never taken said tutorial;
administering a refresher test to said user according to a periodic testing schedule if it is determined that a new user period has ended; and
administering said tutorial to said user after said refresher test if it is determined that said user has failed said refresher test.

54. The method of claim 53, wherein said step of qualifying said user further is comprised of the steps of:
determining whether said user has taken said tutorial with a predetermined exemption frequency;
determining whether it is time to administer said refresher test based on said periodic testing schedule; and
administering said refresher test if it is determined that said user has not taken said tutorial with said predetermined exemption frequency.

55. The method of claim 54, wherein said step of qualifying said user further is comprised of the steps of:
determining whether said user has taken said tutorial at least once every two months;
determining whether said user has taken said refresher test in the past three months; and
administering said refresher test if it is determined that said user has not taken said tutorial at least once every two months.

56. A method of determining whether to request supplemental medical information about a patient, comprising the steps of:
qualifying a user;
receiving from said user patient information about said patient's age, physical build, medical history, and the requested amount of insurance coverage;
determining, based on said patient information and its relation to a set of guidelines, whether to request supplemental medical information;
changing said set of guidelines;
displaying said changes made to said set of guidelines to said user;
storing said changed guidelines in an archive;
receiving a user request to view reference information; and
displaying said reference information to said user.

57. The method of claim 56, wherein said step of qualifying said user is comprised of the steps of:
administering a tutorial to said user if it is determined that said user has never taken said tutorial;
receiving a user request to take said tutorial;
administering said tutorial to said user if it is determined that said user has requested to take said tutorial;
determining whether a new user period has ended;
determining whether said user has taken said tutorial with a predetermined exemption frequency;
determining whether it is time to administer a refresher test based on a periodic testing schedule; and
administering said refresher test if it is determined that said new user period has ended, and it is determined that said user has not taken said tutorial with said predetermined exemption frequency, and it is determined that it is time to administer said refresher test based on said periodic testing schedule.

58. The method of claim 57, wherein said step of administering a tutorial to said user is comprised of the steps of:
displaying to said user tutorial information;
displaying to said user a plurality of questions about said tutorial information;
displaying to said user reference information;
receiving a user answer to each of said questions;
generating a tutorial test score based upon said questions and said answers; and
displaying to said user said tutorial test score.

59. The method of claim 58, wherein the step of displaying reference information to said user is comprised of the steps of:
displaying to said user a plurality of insurance forms;
displaying to said user said set of guidelines;
displaying to said user a plurality of procedures; and
displaying to said user a checksheet.

60. The method of claim 57, wherein said new user period is three months.

61. The method of claim 57, wherein said predetermined exemption frequency is at least once every two months.

62. The method of claim 57, wherein said step of administering a refresher test is comprised of the steps of:
displaying to said user a plurality of refresher questions;
receiving a user answer to each of said refresher questions;
generating a refresher test score based upon said refresher questions and said answers; and
displaying to said user said refresher test score.

63. The method of claim 57, wherein said periodic testing schedule is at least once every three months.

64. The method of claim 56, further comprising:
receiving a user request to contact a system administrator;
displaying to said user a contact form;
receiving input from said user relating to said contact form; and
sending said received input to said system administrator.

65. The method of claim 56, further comprising the step of:
displaying to said user a checksheet.

66. The method of claim 65, further comprising the steps of:
receiving user input relating to a patient; and
displaying said received user input on said checksheet.

67. The method of claim 65, further comprising the step of:
storing said checksheet in a storage medium.

68. The method of claim 65, further comprising the step of:
printing said checksheet.

69. The method of claim 56, wherein said step of displaying reference information is comprised of the steps of:
displaying to said user said set of guidelines;
displaying to said user a plurality of procedures;
displaying to said user a glossary of underwriting terms;
displaying to said user a plurality of insurance forms;
displaying to said user a set of Frequently Asked Questions.

70. A system for assisting in determining whether to request supplemental medical information about a patient, comprising:
at least one server computer;
a plurality of client computers, each of said computers being associated with a user, said plurality of client computers being connected to said at least one server computer over a computer network;
wherein said at least one server computer incorporates at least one computer-readable medium including one or more instructions for receiving patient information from a user, one or more instructions for determining, based on said patient information and its relation to a set of guidelines, whether to request supplemental medical information, and one or more instructions for displaying results that include the determination to said user.

71. The system of claim 70, wherein said one or more instructions for receiving patient information is comprised of:
one or more instructions for receiving information about the patient's age, physical build, medical history, and the requested amount of insurance coverage.

72. The system of claim 70, wherein said at least one computer-readable medium further includes:
one or more instructions for changing said set of guidelines; and
one or more instructions for storing changes made to said set of guidelines in an archive.

73. The system of claim 72, wherein said at least one computer-readable medium further includes:
one or more instructions for displaying the said changes to said user.

74. The system of claim 70, wherein said at least one computer-readable medium further includes:
one or more instructions for storing said results in a storage medium; and
one or more instructions for printing said results.

75. The system of claim 70, wherein said at least one computer-readable medium further includes:
one or more instructions for receiving a user request to contact a system administrator;
one or more instructions for displaying to said user a contact form;
one or more instructions for receiving input from said user; and
one or more instructions for sending said input to said system administrator.

76. The system of claim 70, wherein said at least one computer-readable medium further includes:
one or more instructions for receiving a user request to view reference information; and
one or more instructions for displaying said reference information to said user.

77. The system of claim 76, wherein said one or more instructions for displaying reference information is comprised of:
one or more instructions for displaying to said user said set of guidelines;
one or more instructions for displaying to said user the procedures;
one or more instructions for displaying to said user a glossary of underwriting terms;
one or more instructions for displaying to said user said plurality of insurance forms;
one or more instructions for displaying to said user Frequently Asked Questions.

78. The system of claim 70, wherein said at least one computer-readable medium further includes:
one or more instructions for displaying to said user a checksheet.

79. The system of claim 78, wherein said at least one computer-readable medium further includes:
one or more instructions for receiving user input; and
one or more instructions for displaying said user input on said checksheet.

80. The system of claim 78, wherein said at least one computer-readable medium further includes:
one or more instructions for storing said checksheet in a storage medium.

81. The system of claim 78, wherein said at least one computer-readable medium further includes:
one or more instructions for printing said checksheet.

82. The system of claim 70, wherein said at least one computer-readable medium further includes:
one or more instructions for administering a tutorial to said user.

83. The system of claim 82, wherein said at least one computer-readable medium further includes:
one or more instructions for receiving a user request, during said tutorial, to view reference information; and
one or more instructions for displaying said reference information to said user.

84. The system of claim 83, wherein said one or more instructions for displaying reference information to said user is comprised of:
one or more instructions for displaying to said user a plurality of insurance forms;
one or more instructions for displaying to said user guidelines;
one or more instructions for displaying to said user procedures; and
one or more instructions for displaying to said user a checksheet.

85. The system of claim 82, wherein said one or more instructions for administering a tutorial is comprised of:
one or more instructions for displaying to said user tutorial information;
one or more instructions for displaying to said user questions about said tutorial information;
one or more instructions for receiving user answers to said questions;
one or more instructions for generating a tutorial test score based upon the questions and the answers; and
one or more instructions for displaying to said user said tutorial test score.

86. The system of claim 85, wherein said at least one computer-readable medium includes one or more instructions for transmitting said tutorial test score to a work supervisor.

87. The system of claim 85, wherein said at least one computer-readable medium includes one or more instructions for displaying to said user extra information at the end of said tutorial.

88. The system of claim 70, wherein said at least one computer-readable medium includes one or more instructions for administering a refresher test to said user.

89. The system of claim 88, wherein said one or more instructions for administering a refresher test is comprised of:
one or more instructions displaying to said user refresher questions;
one or more instructions receiving user answers to said refresher questions;
one or more instructions generating a refresher test score based upon the questions and the answers; and
one or more instructions displaying to said user said refresher test score.

90. The system of claim 89, wherein said at least on computer-readable medium includes one or more instructions for transmitting said refresher test score to a work supervisor.

91. The system of claim 70, wherein said at least on computer-readable medium further includes:
one or more instructions for receiving a user request to take a tutorial; and
one or more instructions for administering said tutorial to said user.

92. The system of claim 70, wherein said at least on computer-readable medium further includes:
one or more instructions for receiving a user request to take a refresher test; and
one or more instructions for administering said refresher test to said user.

93. The system of claim 71, wherein said at least on computer-readable medium further includes:
one or more instructions for changing said set of guidelines;
one or more instructions for displaying changes made to said set of guidelines to said user;
one or more instructions for storing changes made to said set of guidelines in an archive;
one or more instructions for receiving a user request to view reference information;
one or more instructions for displaying said reference information to said user;
one or more instructions for storing said results in a storage medium;
one or more instructions for printing said results;
one or more instructions for displaying to said user a checksheet;
one or more instructions for receiving user input;
one or more instructions for displaying said user input on said checksheet;
one or more instructions for storing said checksheet in a storage medium;
one or more instructions for printing said checksheet;
one or more instructions for administering a tutorial to said user; and
one or more instructions for administering a refresher test to said user.

94. A system for assisting in determining whether to request supplemental medical information about a patient, comprising:
at least one server computer;
a plurality of client computers associates with a plurality of users, said plurality of client computers being connected to said at least one server computer over a computer network;
wherein said at least one server computer incorporates at least one computer-readable medium including one or more instructions for qualifying a user, one or more instructions for receiving patient information, one or more instructions for determining, based on said patient information and its relation to a set of guidelines, whether to request supplemental medical information, and one or more instructions for displaying results that include the determination to said user.

95. The system of claim 94, wherein said one or more instructions for receiving patient information is comprised of:
one or more instructions for receiving information about the patient's age, physical build, medical history, and the requested amount of insurance coverage.

96. The system of claim 94, wherein said at least one computer-readable medium further includes:
one or more instructions for changing said set of guidelines; and
one or more instructions for storing in an archive changes made to said set of guidelines.

97. The system of claim 96, wherein said at least one computer-readable medium further includes:
one or more instructions for displaying said changes made to said set of guidelines to said user.

98. The system of claim 94, wherein said at least one computer-readable medium further includes:
one or more instructions for storing said results in a storage medium; and
one or more instructions for printing said results.

99. The system of claim 94, wherein said at least one computer-readable medium further includes:
one or more instructions for receiving a user request to contact a system administrator;
one or more instructions for displaying to said user a contact form;
one or more instructions for receiving input from said user; and
one or more instructions for sending said input to said system administrator.

100. The system of claim 94, wherein said at least one computer-readable medium further includes:
one or more instructions for receiving a user request to view reference information; and
one or more instructions for displaying said reference information to said user.

101. The system of claim 100, wherein said one or more instructions for displaying reference information is comprised of:
one or more instructions for displaying to said user said set of guidelines;
one or more instructions for displaying to said user a plurality of procedures;
one or more instructions for displaying to said user a glossary of underwriting terms;
one or more instructions for displaying to said user a plurality of insurance forms;
one or more instructions for displaying to said user Frequently Asked Questions.

102. The system of claim 94, wherein said at least one computer-readable medium further includes:
one or more instructions for displaying to said user a checksheet.

103. The system of claim 102, wherein said at least one computer-readable medium further includes:
one or more instructions for receiving user input; and
one or more instructions for displaying said user input on said checksheet.

104. The system of claim 102, wherein said at least one computer-readable medium further includes:
one or more instructions for storing said checksheet in a storage medium.

105. The system of claim 102, wherein said at least one computer-readable medium further includes:
one or more instructions for printing said checksheet.

106. The system of claim 94, wherein said at least one computer-readable medium further includes:
one or more instructions for administering a tutorial to said user.

107. The system of claim 106, wherein said at least one computer-readable medium further includes:
one or more instructions for receiving a user request, during said tutorial, to view reference information; and
one or more instructions for displaying said reference information to said user.

108. The system of claim 107, wherein said one or more instructions for displaying reference information to said user is comprised of:
one or more instructions for displaying to said user a plurality of insurance forms;
one or more instructions for displaying to said user said set of guidelines;
one or more instructions for displaying to said user a plurality of procedures; and
one or more instructions for displaying to said user a checksheet.

109. The system of claim 106, wherein the said one or more instructions for administering a tutorial is comprised of:
one or more instructions for displaying to said user tutorial information;
one or more instructions for displaying to said user questions about said tutorial information;
one or more instructions for receiving user answers to said questions;
one or more instructions for generating a tutorial test score based upon the questions and the answers; and
one or more instructions for displaying to said user said tutorial test score.

110. The system of claim 109, wherein said at least one computer-readable medium further includes one or more instructions for transmitting said tutorial test score to a work supervisor.

111. The system of claim 109, wherein said at least one computer-readable medium further includes:
one or more instructions for displaying to said user extra information at the end of said tutorial.

112. The system of claim 106, wherein said one or more instructions for qualifying said user is comprised of:
one or more instructions for administering said tutorial to said user if it is determined that said user has never taken said tutorial.

113. The system of claim 112, wherein said at least one computer-readable medium further includes:
one or more instructions for administering said tutorial to said user if it is determined that said user has not recently taken said tutorial.

114. The system of claim 113, wherein said at least one computer-readable medium further includes:
one or more instructions for administering said tutorial to said user if it is determined that said user has not taken said tutorial in the past two months.

115. The system of claim 94, wherein said at least one computer-readable medium further includes:
one or more instructions for administering a refresher test to said user.

116. The system of claim 115, wherein said one or more instructions for administering a refresher test is comprised of:
one or more instructions for displaying to said user refresher questions;
one or more instructions for receiving user answers to said refresher questions;
one or more instructions for generating a refresher test score based upon the questions and the answers; and
one or more instructions for displaying to said user said refresher test score.

117. The system of claim 116, wherein said at least one computer-readable medium further includes:
one or more instructions for transmitting said refresher test score to a work supervisor.

118. The system of claim 115, wherein said one or more instructions for qualifying said user is comprised of:
one or more instructions for administering said refresher test to said user if it is determined that said user has not recently passed said refresher test; and
one or more instructions for qualifying said user if said user passes said refresher test.

119. The system of claim 118, wherein said one or more instructions for qualifying said user is comprised of:
one or more instructions for administering said refresher test to said user if it is determined that said user has not passed said refresher test in the past three months; and
one or more instructions for qualifying said user if said user passes said refresher test.

120. The system of claim 106, wherein said one or more instructions for qualifying said user is comprised of:
one or more instructions for administering said tutorial to said user if it is determined that said user has never taken said tutorial;
one or more instructions for administering a refresher test to said user at periodic intervals if it is determined that a new user period has ended; and
one or more instructions for administering said tutorial to said user after said refresher test if it is determined that said user has failed said refresher test.

121. The system of claim 106, wherein said at least one computer-readable medium further includes:
one or more instructions for receiving a user request to take said tutorial; and
one or more instructions for administering said tutorial to said user if it is determined that said user has requested to take said tutorial.

122. The system of claim 121 wherein said one or more instructions for qualifying said user is comprised of:
one or more instructions for administering said tutorial to said user if it is determined that said user has never taken said tutorial;
one or more instructions for administering a refresher test to said user according to a periodic testing schedule if it is determined that a new user period has ended; and
one or more instructions for administering said tutorial to said user after said refresher test if it is determined that said user has failed said refresher test.

123. The system of claim 122, wherein said one or more instructions for qualifying said user is further comprised of:
one or more instructions for determining whether said user has taken said tutorial with a predetermined exemption frequency;
one or more instructions for determining whether it is time to administer said refresher test based on said periodic testing schedule; and
one or more instructions for administering said refresher test if it is determined that said user has not taken said tutorial with said predetermined exemption frequency.

124. The system of claim 123, wherein said one or more instructions for qualifying said user is further comprised of:
one or more instructions for determining whether said user has taken said tutorial at least once every two months;
one or more instructions for determining whether said user has taken said refresher test in the past three months; and
one or more instructions for administering said refresher test if it is determined that said user has not taken said tutorial at least once every two months.

125. A system for assisting in determining whether to request supplemental medical information about a patient, comprising:
at least one server computer;
a plurality of client computers associates with a plurality of users, said plurality of client computers being connected to said at least one server computer over a computer network;
wherein said at least one server computer incorporates at least one computer-readable medium including:
one or more instructions for qualifying a user;
one or more instructions for receiving from said user patient information about said patient's age, physical build, medical history, and the requested amount of insurance coverage;
one or more instructions for determining, based on said patient information and its relation to a set of guidelines, whether to request supplemental medical information;
one or more instructions for changing said set of guidelines;
one or more instructions for displaying changes made to said set of guidelines to said user;
one or more instructions for storing said changes made to said set of guidelines in an archive;
one or more instructions for receiving a user request to view reference information; and
one or more instructions for displaying said reference information to said user.

126. The system of claim 125, wherein said one or more instructions for qualifying said user is comprised of:
one or more instructions for administering a tutorial to said user if it is determined that said user has never taken said tutorial;
one or more instructions for receiving a user request to take said tutorial;
one or more instructions for administering said tutorial to said user if it is determined that said user has requested to take said tutorial;
one or more instructions for determining whether a new user period has ended;
one or more instructions for determining whether said user has taken said tutorial with a predetermined exemption frequency;
one or more instructions for determining whether it is time to administer a refresher test based on a periodic testing schedule; and
one or more instructions for administering said refresher test if it is determined that said new user period has ended, and it is determined that said user has not taken said tutorial with said predetermined exemption frequency, and it is determined that it is time to administer said refresher test based on said periodic testing schedule.

127. The system of claim 126, wherein said one or more instructions for administering a tutorial to said user is comprised of:
one or more instructions for displaying to said user tutorial information;
one or more instructions for displaying to said user questions about said tutorial information;
one or more instructions for displaying to said user reference information;
one or more instructions for receiving user answers to said questions;
one or more instructions for generating a tutorial test score based upon said questions and said answers; and
one or more instructions for displaying to said user said tutorial test score.

128. The system of claim 127, wherein said one or more instructions for displaying reference information to said user is comprised of:
one or more instructions for displaying to said user a plurality of insurance forms;
one or more instructions for displaying to said user said set of guidelines;
one or more instructions for displaying to said user a plurality of procedures; and
one or more instructions for displaying to said user a checksheet.

129. The system of claim 126, wherein said new user period is three months.

130. The system of claim 126, wherein said predetermined exemption frequency is at least once every two months.

131. The system of claim 126, wherein said one or more instructions for administering a refresher test is comprised of:
one or more instructions for displaying to said user refresher questions;
one or more instructions for receiving user answers to said refresher questions;
one or more instructions for generating a refresher test score based upon said refresher questions and said answers; and
one or more instructions for displaying to said user said refresher test score.

132. The system of claim 126, wherein said periodic testing schedule is at least once every three months.

133. The system of claim 125, wherein said at least one computer-readable medium further includes:
one or more instructions for receiving a user request to contact a system administrator;
one or more instructions for displaying to said user a contact form;
one or more instructions for receiving input from said user; and
one or more instructions for sending said input to said system administrator.

134. The system of claim 125, wherein said at least one computer-readable medium further includes:
one or more instructions for displaying to said user a checksheet.

135. The system of claim 134, wherein said at least one computer-readable medium further includes:
one or more instructions for receiving user input; and
one or more instructions for displaying said user input on said checksheet.

136. The system of claim 134, wherein said at least one computer-readable medium further includes:
one or more instructions for storing said checksheet in a storage medium.

137. The system of claim 134, wherein said at least one computer-readable medium further includes:
one or more instructions for printing said checksheet.

138. The system of claim 125, wherein said step of displaying reference information is comprised of the steps of:
one or more instructions for displaying to said user said set of guidelines;
one or more instructions for displaying to said user a plurality of procedures;
one or more instructions for displaying to said user a glossary of underwriting terms;
one or more instructions for displaying to said user a plurality of insurance forms;
one or more instructions for displaying to said user Frequently Asked Questions.
